(19) United States
(12) Patent Application Publication
(10) Pub. No.: US 2005/0234611 A1
(43) Pub. Date: Oct. 20, 2005

(54) Self-propelled cleaner

(75) Inventor: Naoya Uehigashi, Osaka (JP)

Correspondence Address: Yokoi & Co., U.S.A., Inc., 13700 Marina Pointe Drive #1512, Marina Del Rey, CA, 90292, US

(73) Assignee: Funai Electric Co., Ltd., Osaka (JP)

(21) Appl. No.: 11/104,753

(22) Filed: Apr. 13, 2005

(30) Foreign Application Priority Data
Apr. 15, 2004 (JP) JP2004-120607

(51) Int. Cl. G05D 1/00

(52) U.S. Cl. 701/23

(57) ABSTRACT

There are robots that make an emotional expression with light and sound but they are very typical and lack something that attract the user. According to the present invention, in a self-propelled cleaner, after selection of the type of emotion at step S404, an operation step sequence appropriate to the selected type of emotion is chosen at steps S406 to S410 where steps S412 to S416 are carried out for joy, S418 to S422 for anger, S424 to S428 for sadness, and S430 to S434 for delight. At steps S414, S420, S428 and S432, the pattern of power supply to the suction motor is determined to vary the suction sound pattern according to the selected type of emotion to express an emotion.

### BACKGROUND OF THE INVENTION

1. Field of the Invention

This invention relates to a self-propelled cleaner comprising a body with a cleaning mechanism and a drive mechanism capable of steering and driving the cleaner.

2. Description of the Prior Art

A self-propelled robot as disclosed in JP-A No. 361582/2002 has been known. This robot can control the color, intensity and blinking speed of light from lamps provided in the robot and the intensity, reproduction speed and tone of sound or voice which it produces.

The robot can make a pseudo-emotional expression using this control capability as appropriate.

On the other hand, JP-A No. 167628/2003 discloses a self-propelled cleaner which automatically controls its own behavior with supersonic sensors on the sides of its body.

Out of the above conventional robots, the former, which attempts to make an emotional expression with light and sound, is a very typical robot and lacks something that attracts the user; and the latter is definitely categorized as a cleaner and has no function of emotional expressions.

### SUMMARY OF THE INVENTION

This invention has been made in view of the above mentioned problem and provides a unique self-propelled cleaner that is capable of cleaning while traveling by self-propulsion.

According to one aspect of the invention, a self-propelled cleaner has a body with a vacuum cleaning mechanism driven by a suction motor, and a drive mechanism capable of steering and driving the cleaner. It includes: an emotion type selection processor which has a human sensor to detect a human body and, upon detection of a human body, selects the type of emotion to be expressed; a suction sound control processor which controls the rotation of the suction motor to vary the suction sound depending on the selected type of emotion; and a motion control processor which controls the drive mechanism to control motion of the body depending on the selected type of emotion.

In the system constructed as above, the cleaning mechanism has a suction motor which permits vacuum cleaning and the drive mechanism enables the body to be steered and travel. The emotion type selection processor uses a human sensor which detects a human body and, upon detection of a human body, selects the type of emotion to be expressed. After selection of the type of emotion, the suction sound control processor controls the rotation of the suction motor to vary the suction sound depending on the selected type of emotion; and the motion control processor controls the drive mechanism to control motion of the body depending on the selected type of emotion.

As mentioned above, on the premise of the self-propelling cleaning capability, the suction sound is varied to express various emotions by controlling the rotation of the suction motor. Emotional expressions are made not only by various suction sounds but also by various motions of the body.

According to another aspect of the invention, in order to vary the suction sound, an adapter is mounted in a suction channel and an exhaust channel for the suction motor.

In the system constructed as above, the adapter is mounted in the suction channel and exhaust channel to express emotions. The adapter makes it possible to generate a considerably different sound from a normal suction sound, permitting a variety of emotional expressions.

The cleaning mechanism may use another cleaning method in addition to the basic vacuum cleaning function. According to another aspect of the invention, the cleaning mechanism has side brushes protruding outward from both sides of the body and side brush motors for driving the side brushes and the side brush motors are controlled depending on the selected type of emotion.

In the system constructed as above, the side brushes, which protrude outward from both sides of the body, can be visually checked from outside. Therefore, the side brush motors for driving the side brushes are controlled so that an emotional expression is made by motion of the side brushes.

It is possible to adopt various motions for emotional expressions. According to another aspect of the invention, the motion control processor enables the body to approach a human body, move away from a human body or move around a human body through the drive mechanism.

In the system constructed as above, when a human body is detected, the body approaches the human body to express joy, moves away from it to express sadness or anger and moves around it to further express joy.

The drive mechanism capable of steering and driving the cleaner may be embodied in various forms. The drive mechanism may use endless belts instead of drive wheels. The number of wheels in the drive mechanism is not limited to two; it may be four, six or more.

As one concrete example of the above system, according to another aspect of the invention, a self-propelled cleaner has a body with a vacuum cleaning mechanism driven by a suction motor and a drive mechanism with drive wheels at the left and right sides of the body whose rotation can be individually controlled for steering and driving the cleaner. The cleaning mechanism has: side brushes protruding outward from both sides of the body; side brush motors for driving the side brushes; and an adapter which is mounted in a suction channel and an exhaust channel for the suction motor to vary the suction sound. The cleaner further includes: an emotion type selection processor which has a human sensor to detect a human body and selects the type of emotion to be expressed; a suction sound control processor which controls the rotation of the suction motor to vary the suction sound depending on the selected type of emotion; and a motion control processor which controls the drive mechanism to selectively make the body approach a human body, move away from a human body or move around a human body depending on the selected type of emotion.

The system constructed as above not only provides an inherent cleaning mechanism with a self-propelling function but also serves as a robot which detects a human body, selects the type of emotion to be expressed and makes a unique emotional expression by means of suction sound and motions of its side brushes and body.

### BRIEF DESCRIPTION OF THE DRAWINGS

FIG. 1 is a block diagram schematically showing the construction of a self-propelled cleaner according to this invention;

FIG. 2 is a more detailed block diagram of the self-propelled cleaner;

FIG. 3 is a block diagram of an AF passive sensor unit;

FIG. 4 illustrates the position of a floor relative to the AF passive sensor unit and how ranging distance changes when the AF passive sensor unit is oriented downward obliquely toward the floor;

FIG. 5 illustrates the ranging distance in the imaging range when an AF passive sensor for the immediate vicinity is oriented downward obliquely toward the floor;

FIG. 6 illustrates the positions and ranging distances of individual AF passive sensors;

FIG. 7 is a flowchart showing a traveling control process;

FIG. 8 is a flowchart showing a cleaning traveling process;

FIG. 9 shows a travel route in a room;

FIG. 10 is a plan view schematically showing the arrangement of brushes;

FIG. 11 is a sectional view schematically showing brushes and a suction fan;

FIG. 12 illustrates an operation mode select screen;

FIG. 13 is a flowchart of a pet mode;

FIG. 14 is a table showing relations between motions and sound patterns for different types of emotion;

FIG. 15 is a sectional view schematically showing how an adapter for varying the suction sound is mounted; and

FIG. 16 is a sectional view schematically showing a cover which makes the robot look like a pet.

### DESCRIPTION OF THE PREFERRED EMBODIMENTS

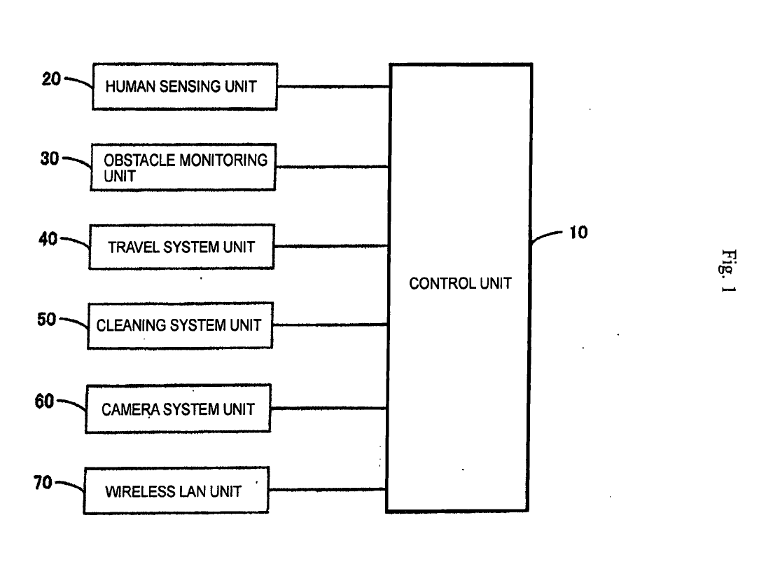

As shown in FIG. 1, according to this invention, the cleaner includes a control unit 10 to control individual units; a human sensing unit 20 to detect a human or humans around the cleaner; an obstacle monitoring unit 30 to detect an obstacle or obstacles around the cleaner; a traveling system unit 40 for traveling; a cleaning system unit 50 for cleaning; a camera system unit 60 to take a photo of a given area; and a wireless LAN unit 70 for wireless connection to a LAN. The body of the cleaner has a low profile and is almost cylindrical.

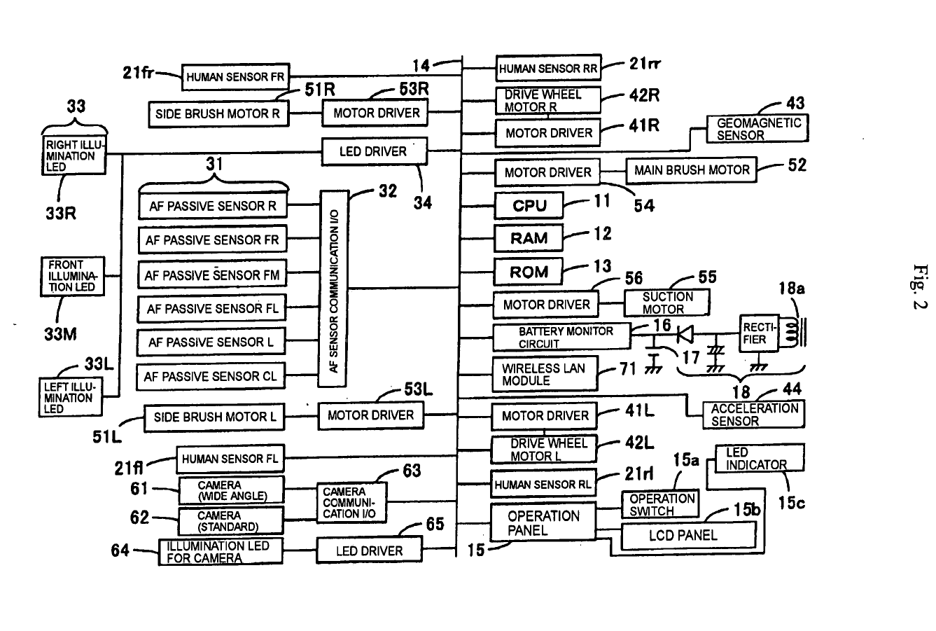

As shown in FIG. 2, a block diagram showing the electrical system configuration for the individual units, a CPU 11, a ROM 13, and a RAM 12 are interconnected via a bus 14 to constitute a control unit 10. The CPU 11 performs various control tasks using the RAM 12 as a work area according to a control program stored in the ROM 13 and various parameter tables. The control program will be described later in detail.

The bus 14 is equipped with an operation panel 15 on which various types of operation switches 15a, a liquid crystal display panel 15b, and LED indicators 15c are provided. Although the liquid crystal display panel is a monochrome liquid crystal panel with a multi-tone display function, a color liquid crystal panel or the like may also be used.

This self-propelled cleaner has a battery 17 and allows the CPU 11 to monitor the remaining amount of the battery 17 through a battery monitor circuit 16. The battery 17 is equipped with a charge circuit 18 that charges the battery with electric power supplied in a non-contact manner through an induction coil 18a. The battery monitor circuit 16 mainly monitors the voltage of the battery 17 to detect its remaining amount.

The human sensing unit 20 consists of four human sensors 21 (21fr, 21rr, 21f1, 21r1), two of which are disposed obliquely at the left and right sides of the front of the body and the other two at the left and right sides of the rear of the body. Each human sensor 21 has an infrared light-receiving sensor that detects the presence of a human body based on the amount of infrared light received. When the human sensor detects an irradiated object which changes the amount of infrared light received, the CPU 11 obtains the result of detection by the human sensor 21 via the bus 14 to change the status for output. In other words, the CPU 11 obtains the status of each of the human sensors 21fr, 21rr, 21f1, and 21r1 at each predetermined time and detects the presence of a human body in front of the human sensor 21fr, 21rr, 21f1, or 21r1 by a change in the status.

Although the human sensors described above detect the presence of a human body based on changes in the amount of infrared light, the human sensors are not limited to this type. For example, if the CPU's processing capability is increased, it is possible to take a color image of a target area, identify a skin-colored area that is characteristic of a human body and detect the presence of a human body based on the size of the area and/or change.

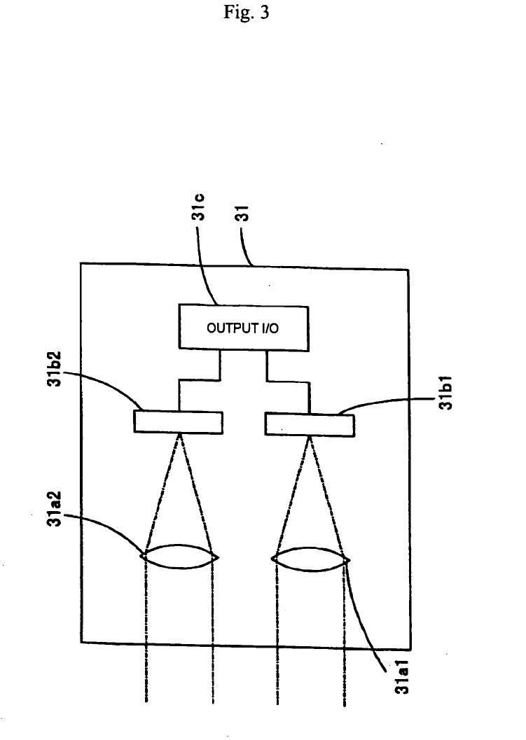

The obstacle monitoring unit 30 consists of a passive sensor unit 31 composed of ranging sensors for auto focus (hereinafter called AF) (31R, 31FR, 31FM, 31FL, 31L, 31CL); an AF sensor communication I/O 32 as a communication interface to the passive sensor unit 31; illumination LEDs 33; and an LED driver 34 to supply driving current to each LED. First, the construction of the AF passive sensor unit 31 will be described. FIG. 3 schematically shows the construction of the AF passive sensor unit 31. It includes a biaxial optical system consisting of almost parallel optical systems 31a1 and 31a2; CCD line sensors 31b1 and 31b2 disposed approximately in the image focus positions of the optical systems 31a1 and 31a2 respectively; and an output I/O 31c to output image data taken by each of the CCD line sensors 31b1 and 31b2 to the outside.

The CCD line sensors 31b1 and 31b2 each have a CCD sensor with 160 to 170 pixels and can output 8-bit data representing the amount of light for each pixel. Since the optical system is biaxial, the discrepancy between two formed images varies depending on the distance, which means that it is possible to measure a distance based on a difference between data from the CCD line sensors 31b1 and 31b2. As the distance decreases, the discrepancy between formed images increases, and vice versa. Therefore, an actual distance is determined by scanning data rows (4 to 5 pixels/row) in output image data, finding the difference between the address of an original data row and that of a discovered data row, and then referencing a difference-to-distance conversion table prepared in advance.

The AF passive sensors 31FR, 31FM, and 31FL are used to detect an obstacle in front of the cleaner while the AF passive sensors 31R and 31L are used to detect an obstacle on the right or left ahead in the immediate vicinity. The AF passive sensor 31CL is used to detect a distance up to the ceiling ahead.

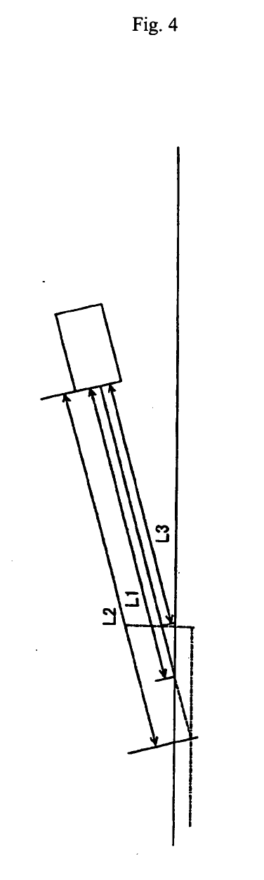

FIG. 4 shows the principle under which the AF passive sensor unit 31 detects an obstacle in front of the cleaner or on the immediate right or left ahead. The AF passive sensor unit 31 is oriented obliquely toward the surrounding floor surface. If there is no obstacle on the opposite side, the ranging distance covered by the AF passive sensor unit 31 in the almost whole imaging range is expressed by L1. However, if there is a step or floor level difference as indicated by alternate long and short dash line in the figure, the ranging distance is expressed by L2. Namely, an increase in the ranging distance suggests the presence of a step. If there is a floor level rise as indicated by alternate long and two dashes line, the ranging distance is expressed by L3. If there is an obstacle, the ranging distance is calculated as the distance to the obstacle as when there is a floor level rise, and it is shorter than the distance to the floor.

In this embodiment, when the AF passive sensor unit 31 is oriented obliquely toward the floor surface ahead, its imaging range is approx. 10 cm. Since this self-propelled cleaner has a width of 30 cm, the three AF passive sensors 31FR, 31FM and 31FL are arranged at slightly different angles so that their imaging ranges do not overlap. This arrangement allows the three AF passive sensors 31FR, 31FM and 31FL to detect an obstacle or step in a 30-cm wide area ahead of the cleaner. The detection area width varies depending on the sensor model and position, and the number of sensors should be determined according to the actually required detection area width.

Regarding the AF passive sensors 31R and 31L which detect an obstacle on the immediate right and left ahead, their imaging ranges are vertically oblique to the floor surface. The AF passive sensor 31R is mounted at the left side of the body so that a rightward area beyond the width of the body is shot across the center of the body from the immediate right and the AF passive sensor 31L is mounted at the right side of the body so that a leftward area beyond the width of the body is shot across the center of the body from the immediate left.

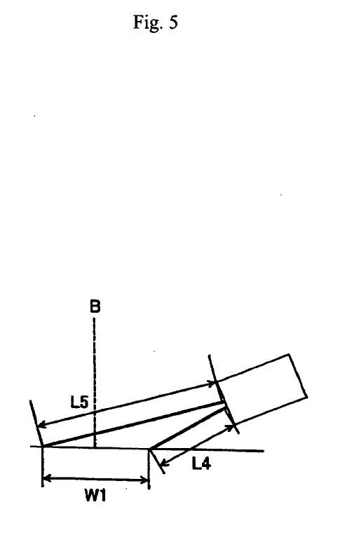

If the left and right sensors should be located so as to cover the leftward and rightward areas just before them respectively, they would have to be sharply angled with respect to the floor surface and the imaging range would be very narrow. As a consequence, more than one sensor would be needed on each side. For this reason, it is arranged that the left sensor covers the rightward area and the right sensor covers the leftward area in order to obtain a wider imaging range with a smaller number of sensors. The CCD line sensors are arranged vertically so that the imaging range is vertically oblique, and as shown in FIG. 5, the imaging range width is expressed by W1. Here, L4, distance to the floor surface on the right of the imaging range, is short and L5, distance to the floor surface on the left, is long. The imaging range portion up to the border line is used to detect a step or the like and the imaging range portion beyond the border line is used to detect a wall, where the border line of the body BD's side is expressed by dashed line B in the figure.

The AF passive sensor 31CL, which detects a distance to the ceiling ahead, faces the ceiling. Usually, the distance from the floor surface to the ceiling which is detected by the AF passive sensor 31CL is constant but as it comes closer to a wall surface, it covers not the ceiling but the wall surface and the ranging distance becomes shorter. Hence, the presence of a wall can be detected more accurately.

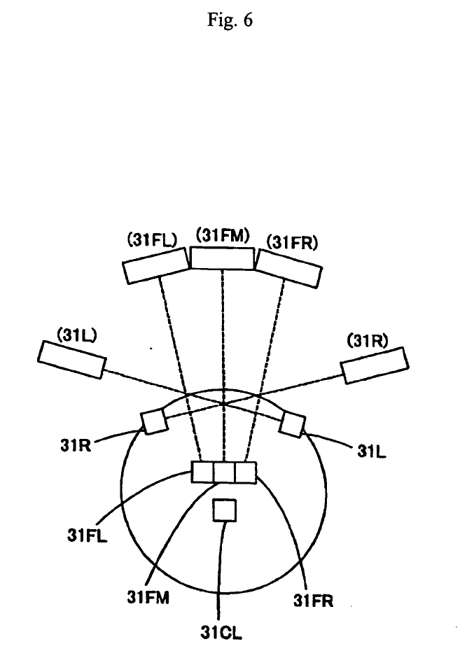

FIG. 6 shows how the AF passive sensors 31R, 31FR, 31EM, 31FL, 31L and 31CL are located on the body BD where the respective floor imaging ranges covered by the sensors are represented by the corresponding code numbers in parentheses. The ceiling imaging range is omitted here.

The cleaner has the following white LEDs: a right illumination LED 33R, a left illumination LED 33L and a front illumination LED 33M to illuminate the images from the AF passive sensors 31R, 31FR, 31FM, 31FL and 31L; and an LED driver 34 supplies a driving current to illuminate the images according to an instruction from the CPU 11. Therefore, even at night or in a dark place (under the table, etc), it is possible to acquire image data from the AF passive sensor unit 31 effectively.

The traveling system unit 40 includes: motor drivers 41R, 41L; drive wheel motors 42R, 42L; and a gear unit (not shown) and drive wheels driven by the drive wheel motors 42R and 42L. A drive wheel is provided on each side (right and left) of the body. In addition, a free rolling wheel without a drive source is attached to the center bottom of the front side of the body. The rotation direction and angle of the drive wheel motors 42R and 42L can be accurately controlled by the motor drivers 41R and 41L which output drive signals according to an instruction from the CPU 11. From output of rotary encoders integral with the drive wheel motors 42R and 42L, the actual drive wheel rotation direction and angle can be accurately detected. Alternatively, the rotary encoders may not be directly connected with the drive wheels but a driven wheel which can rotate freely may be located near a drive wheel so that the actual amount of rotation can be detected by feedback of the amount of rotation of the driven wheel even if the drive wheel slips. The traveling system unit 40 also has a geomagnetic sensor 43 so that the traveling direction can be determined according to the geomagnetism. An acceleration sensor 44 detects the acceleration velocity in the X, Y and Z directions and outputs the detection result.

The gear unit and drive wheels may be embodied in any form and they may use circular rubber tires or endless belts.

The cleaning mechanism of the self-propelled cleaner consists of: side brushes located forward at both sides which gather dust beside each side of the body in the advance direction and bring the gathered dust toward the center of the body BD; a main brush which scoops the gathered dust in the center; and a suction fan which takes the dust scooped by the main brush into a dust box by suction. The cleaning system unit 50 consists of: side brush motors 51R and 51L and a main brush motor 52; motor drivers 53R, 53L and 54 for supplying driving power to the motors; a suction motor 55 for driving the suction fan; and a motor driver 56 for supplying driving power to the suction motor. The CPU 11 appropriately controls cleaning operation with the side brushes and main brush depending on the floor condition and battery condition or a user instruction.

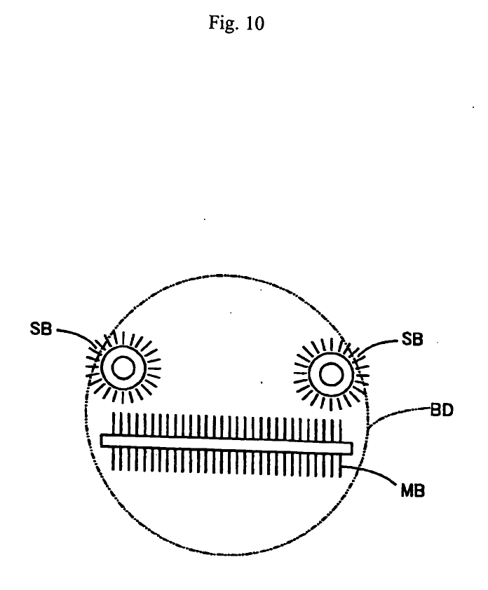

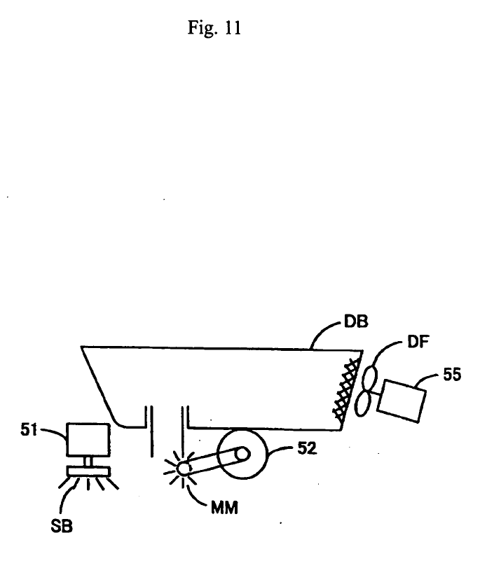

FIG. 10 is a plan view which shows the arrangement of side brushes SB and a main brush MB. The main brush MB lies across the body BD and a pair of side brushes SB are located at the right and left sides in front of the main brush MB. FIG. 11 schematically shows the positional relation among the side brushes SB, main brush MB and suction fan DF. The main brush MB, located under a suction hole DT communicated with a dust box DB, scoops dust and the scooped dust is sucked into the dust box DB by negative pressure generated by the suction fan DF located behind the dust box DB.

The camera system unit 60 has two CMOS cameras 61 and 62 with different viewing angles which are mounted on the front side of the body at different angles of elevation. A camera communication I/O 63 which gives the camera 61 or 62 an instruction to take a photo and outputs the photo image. In addition, it has a camera illumination LED array 64 composed of 15 white LEDs oriented toward the direction in which the cameras 61 and 62 take photos, and an LED driver 65 for supplying driving power to the LEDs.

The wireless LAN unit 70 has a wireless LAN module 71 so that the CPU 11 can be connected with an external LAN wirelessly in accordance with a prescribed protocol. The wireless LAN module 71 assumes the presence of an access point (not shown) and the access point should be connectable with an external wide area network (for example, the Internet) through a router. Therefore, ordinary mail transmission and reception through the Internet and access to websites are possible. The wireless LAN module 71 is composed of a standardized card slot and a standardized wireless LAN card to be connected with the slot. Of course other standardized cards can be connected to the card slot as well.

Next, how the above self-propelled cleaner works will be described.

(1) Cleaning Operation

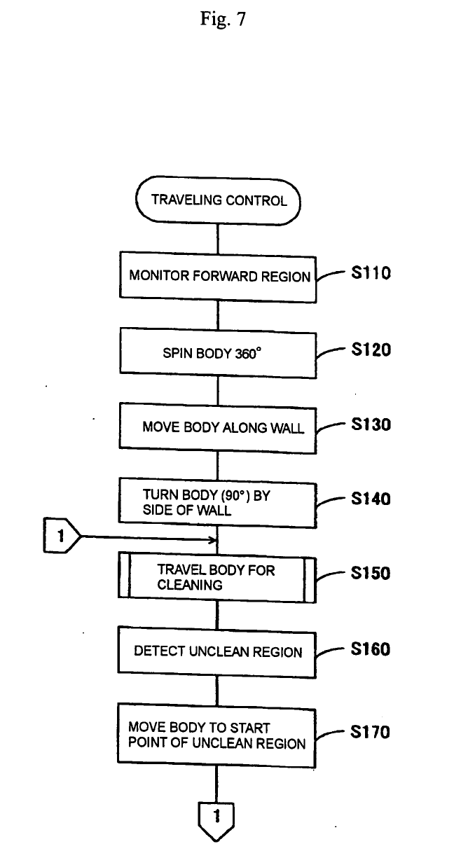

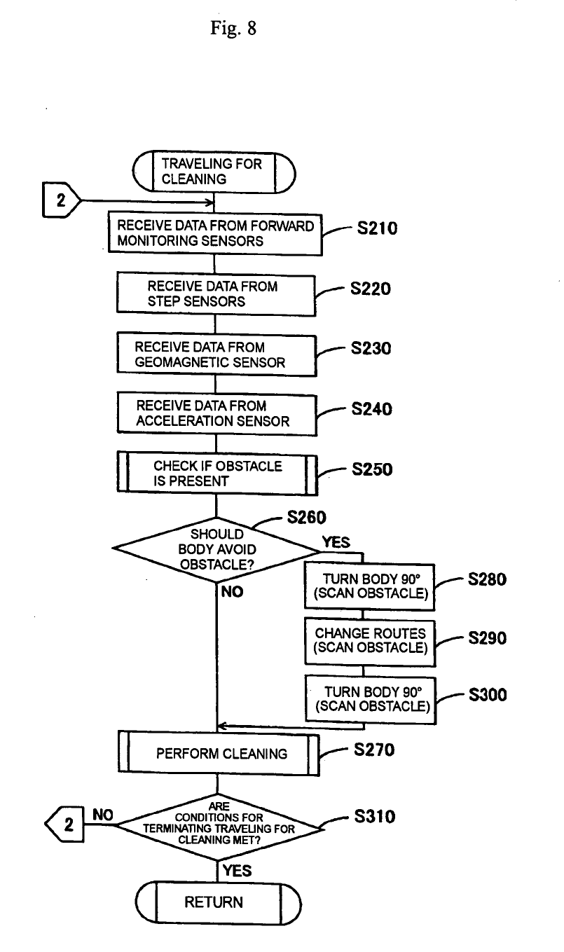

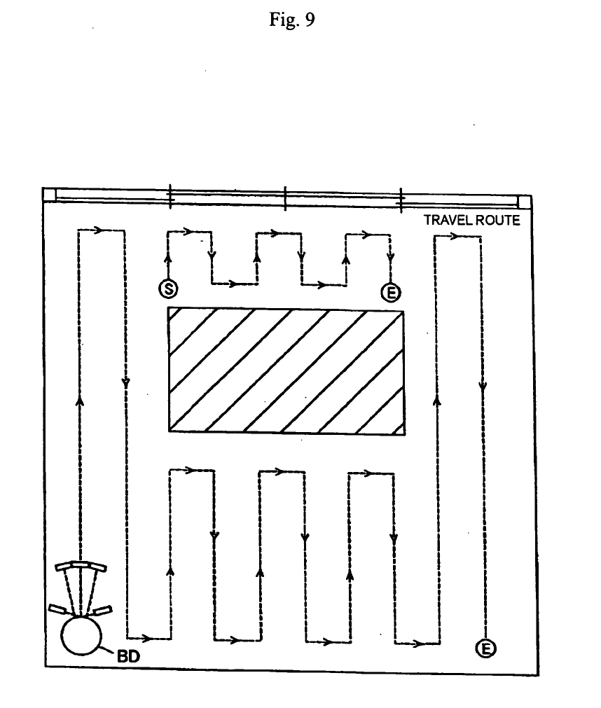

FIGS. 7 and 8 are flowcharts which correspond to a control program which is executed by the CPU 11; and FIG. 9 shows a travel route along which this self-propelled cleaner moves under the control program.

When the power is turned on, the CPU 11 begins to control traveling as shown in FIG. 7. At step S110, it receives the results of detection by the AF passive sensor unit 31 and monitors a forward region. In monitoring the forward region, reference is made to the results of detection by the AF passive sensors 31FR, 31FM and 31F; and if the floor surface is flat, the distance L1 to the floor surface (located downward in an oblique direction as shown in FIG. 4) is obtained from an image thus taken. Whether the floor surface in the forward region corresponding to the body BD's width is flat or not is decided based on the results of detection by the AF passive sensors 31FR, 31FM and 31FL. However, at this moment, no information on the space between the body's immediate vicinity and the floor surface regions facing the AF passive sensors 31FR, 31FM and 31FL is not obtained so the space is a dead area.

At step S120, the CPU 11 orders the drive wheel motors 42R and 42L to rotate in different directions by equal amount through the motor drivers 41R and 41L respectively. As a consequence, the body begins turning on the spot. The rotation amount of the drive motors 42R and 42L required for 360-degree turn on the same spot (spin turn) is known and the CPU 11 informs the motor drivers 41R and 41L of that required rotation amount.

During this spin turn, the CPU 11 receives the results of detection by the AF passive sensors 31R and 31L and judges the condition of the immediate vicinity of the body BD. The above dead area is almost covered (eliminated) by the results of detection obtained during this spin turn, and if there is no step or obstacle there, it is confirmed that the surrounding floor surface is flat.

At step 130, the CPU 11 orders the drive wheel motors 42R and 42L to rotate by equal amount through the motor drivers 41R and 41L respectively. As a consequence, the body begins moving straight ahead. During this straight movement, the CPU 11 receives the results of detection by the AF passive sensors 31FR, 31FM and 3FL and the body advances while checking whether there is an obstacle ahead. The above dead area is almost covered by the detection made during this spin turn. When a wall surface as an obstacle ahead is detected, the body stops a prescribed distance short of the wall surface.

At step S140, the body turns clockwise by 90 degrees. The prescribed distance short of the wall at step S130 corresponds to a distance that the body BD can turn without colliding against the wall surface and the AF passive sensors 31R and 31L can monitor their immediate vicinity and rightward and leftward regions beyond the body width. In other words, the distance should be such that when the body turns 90 degrees at step S140 after it stops according to the results of detection by the AF passive sensors 31FR, 31FM and 31FL at step S130, the AF passive sensor 31L can at least detect the position of the wall surface. Before it turns 90 degrees, the condition of its immediate vicinity should be judged according to the results of detection by the AF passive sensors 31R and 31L. FIG. 9 is a plan view which shows the cleaning start point (in the left bottom corner of the room as shown) which the body has thus reached.

There are various other methods of reaching the cleaning start point. If the body should turn only clockwise 90 degrees in contact with the wall surface, cleaning would begin midway on the first wall. If the body reaches the optimum position in the left bottom corner as shown in FIG. 9, it is also desirable to control its travel so that it turns counterclockwise 90 degrees in contact with the wall surface and advances until it touches the front wall surface, and upon touching the front wall surface, it turns 180 degrees.

At step S150, the body travels for cleaning. FIG. 8 is a flowchart which shows cleaning traveling steps in detail. Before advancing or moving forward, the CPU 11 receives the results of detection by various sensors at steps S210 to S240. At step S210, it receives forward monitoring sensor data (specifically the results of detection by the AF passive sensors 31FR, 31FM, 31FL and 31CL) which is used to judge whether or not there is an obstacle or wall surface ahead in the traveling area. Forward monitoring here includes monitoring of the ceiling in a broad sense.

At step S220, the CPU 11 receives step sensor data (specifically the results of detection by the AF passive sensors 31R and 31L) which is used to judge whether or not there is a step in the immediate vicinity of the body in the traveling area. Also, while the body moves along a wall surface or obstacle, the distance to the wall surface or obstacle is measured in order to judge whether or not it is moving in parallel with the wall surface or obstacle.

At step 230, the CPU 11 receives geomagnetic sensor data (specifically the result of detection by the geomagnetic sensor 43) which is used to judge whether or not there is any change in the traveling direction of the body which is moving straight. For example, the angle of geomagnetism at the cleaning start point is memorized and if an angle detected during traveling is different from the memorized angle, the amounts of rotation of the left and right drive wheel motors 42R and 42L are slightly differentiated to adjust the traveling direction to restore the original angle. If the angle becomes larger than the original angle of geomagnetism (change from 359 degrees to 0 degree is an exception), it is necessary to adjust the traveling direction to make it more leftward. Hence, an instruction is given to the motor drivers 41R and 41L to make the amount of rotation of the right drive wheel motor 42R slightly larger than that of the left drive wheel motor 42L.

At step S240, the CPU 11 receives acceleration sensor data (specifically the result of detection by the acceleration sensor 44) which is used to check the traveling condition. For example, if acceleration in substantially one direction is sensed at the start of rectilinear traveling, the traveling is recognized to be normal. If acceleration in a varying direction is sensed, an abnormality that one of the drive wheel motors is not driven is recognized. If a detected acceleration velocity is out of the normal range, a fall from a step or an overturn is suspected. If a considerable backward acceleration is detected, collision against an obstacle ahead is suspected. Although there is no direct acceleration control function (for example, a function to keep a desired acceleration velocity by input of an acceleration value or achieve a desired acceleration velocity based on integration), acceleration data is effectively used to detect an abnormality.

At step S250, the system checks whether there is an obstacle, according to the results of detection by the AF passive sensors 31FR, 31FM, 31CL, 31FL, 31R and 31L which the CPU 11 have received at steps S210 and S220. This check is made for each of the forward regions, ceiling and immediate vicinity. Here a forward region refers to an area ahead where detection is made for an obstacle or wall surface; and the immediate vicinity refers to an area where detection for a step is made and the condition of regions on the left and right of the body beyond the traveling width is checked (presence of a wall, etc). The ceiling here refers to an area where detection is made, for example, for a door lintel underneath the ceiling which leads to a hall and might cause the body to go out of the room.

At step S260, the system evaluates the results of detection by the sensors comprehensively to decide whether to avoid an obstacle or not. As far as there is no obstacle to be avoided, a cleaning process at step S270 is carried out. The cleaning process refers to a process that dust is sucked in while the side brushes and main brush are rotating. Concretely, an instruction is issued to the motor drivers 53R, 53L, 54 and 56 to drive the motors 51R, 51L, 52 and 55. Obviously the same instruction is always given during traveling and when the conditions to terminate traveling for cleaning are met, the body stops traveling.

On the other hand, if it is decided that the body must avoid an obstacle (do escape motion), it turns clockwise 90 degrees at step S280. This is a 90-degree turn on the same spot which is achieved by giving an instruction to the drive wheel motors 42R and 42L through the motor drivers 41R and 41L respectively to turn them indifferent directions by the amount necessary for the 90-degree turn. Here, the right drive wheel should turn backward and the left drive wheel should turn forward. During the turn, the CPU 11 receives the results of detection by the AF passive sensors 31R and 31L as step sensors and checks for an obstacle. When an obstacle ahead is detected and the body turns clockwise 90 degrees, if the AF passive sensor 31R does not detect a wall ahead on the right in the immediate vicinity, it maybe considered to have simply touched a forward wall, but if a wall surface ahead on the right in the immediate vicinity is still detected even after the turn, the body may be considered to get caught in a corner. If neither of the AF passive sensors 31R and 31L detects an obstacle ahead in the immediate vicinity during 90-degree turn, it can be thought that the body has not touched a wall but there is a small obstacle.

At step S290, the body advances to change routes or turn while scanning for an obstacle. It touches the wall surface and turns clockwise 90 degrees, then advances. If it has stopped short of the wall, the distance of the advance is almost equal to the body BD's width. After advance by that distance, the body turns clockwise 90 degrees again at step S300.

During the above movement, the forward region and leftward and rightward regions ahead are always scanned for an obstacle and the result of this monitoring scan is memorized as information on the presence of an obstacle in the room.

As explained above, a 90-degree clockwise turn is made twice. If the body should turn clockwise 90 degrees upon detection of a next wall ahead, it would return to its original position. Therefore, after it turns clockwise 90 degrees twice, it should turn counterclockwise twice and then clockwise twice, namely in alternate directions. This means that it should turn clockwise at an odd-numbered time of escape motion and counterclockwise at an even-numbered time of escape motion.

The system continues traveling for cleaning while scanning the room in a zigzag pattern and avoiding an obstacle as described so far. Then at step S310, whether it has reached the end of the room or not is decided. After the second turn, if the body has advanced along the wall and has detected an obstacle ahead, or if it has entered a region where it already traveled, it is decided that the body has reached the cleaning traveling termination point. In other words, the former situation can occur after the last end-to-end travel in the zigzag movement; and the latter situation can occur when a region left unclean is found and cleaning traveling is started again.

If either of these conditions is not met, the system goes back to step S210 and repeats the abovementioned steps. If either of the conditions is met, the system finishes the cleaning traveling subroutine and returns to the process of FIG. 7.

After returning to the process of FIG. 7, at step S160, the system judges from the collected information on the traveled regions and their surroundings as to whether or not there is any region left unclean. Various known methods of detection for an unclean region are available. One of such methods is to map regions traveled so far and store information on them. In this example, based on the abovementioned rotary encoder detection results, the travel route (traveled regions) in the room and information on wall surfaces detected during traveling are written in a map reserved in a memory area. The presence of an unclean region is determined from the map by checking whether or not, in the map, the surrounding wall surface is continuous and the regions around obstacles in the room are all continuous and the body has traveled across all regions of the room except the obstacles. If an unclean region is found, the body moves to the start point of the unclean region at step S170 and the system returns to step S150 and starts cleaning traveling again.

Even if there are several unclean regions here and there, each time the conditions to terminate cleaning traveling is met, detection for an unclean region is repeated as described above until there is no unclean region.

(2) Pet Mode

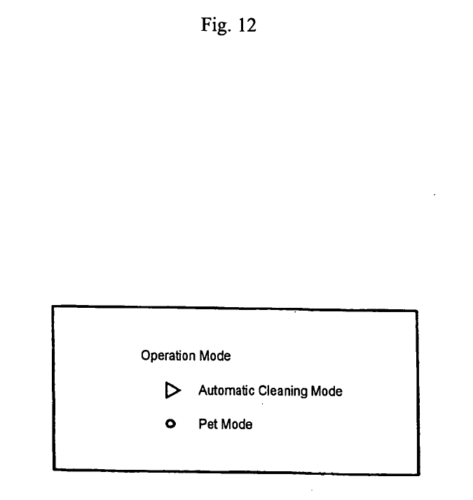

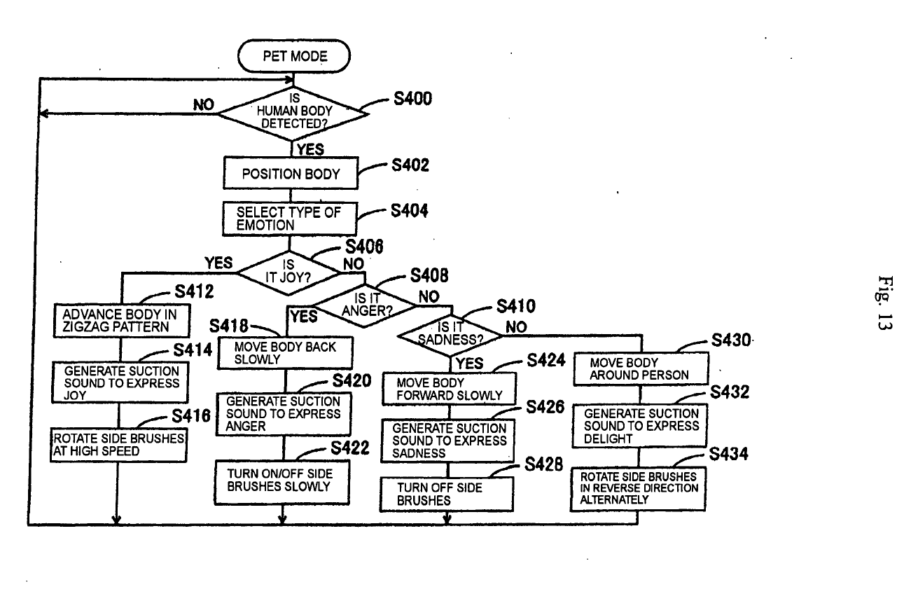

FIG. 12 shows a liquid crystal display panel 15b which enables the user to select an operation mode of the self-propelled cleaner using an operation switch 15a. As shown in the figure, the user can select either an automatic cleaning mode or a pet mode using the operation switch 15a. When the automatic cleaning mode is selected, the CPU 11 controls operation according to the flowcharts of FIGS. 7 and 8; and when the pet mode is selected, it controls operation according to the flowchart of FIG. 13.

In the pet mode, the CPU 11 carries out steps as shown in the flowchart of FIG. 13. At step S400, it acquires the results of detection by the human sensors 21 and judges whether there is a human body around the cleaner. When a human body is detected, the body performs a motion while generating a sound which expresses joy, anger, sadness and delight. Therefore, at step 400 the cleaner stands by until the human sensors 21 detects a human body.

As the human sensors 21 detects a human body, the CPU 11 positions the body so as to face the human body at step S402. For this positioning, the CPU 11 measures the relative angle between the human body and the body BD and moves the body BD to eliminate the relative angle. For measurement of the relative angle, the human sensors 21 detect either the infrared intensity of an infrared emitting object or simply the presence/absence of an infrared emitting object and outputs the result of detection.

When the infrared intensity is to be detected, not a single human sensor 21 but several human sensors 21 work. The system obtains the highest intensity detection result outputs from two human sensors 21 and detects the angle of the infrared emitting body within a 90-degree angle range zone between the detection ranges of these human sensors. It calculates the intensity ratio of detection result outputs of the two human sensors 21 and refers to a table prepared based on experimentation. This table stores the relationship between intensity ratio and angle. This table is referenced to find the angle of the object within the 90-degree angle range and the object's relative angle with respect to the body BD is calculated based on the locations of the two human sensors 21 whose detection result outputs have been used. For example, if the human sensors 21fr and 21rr located on the right side of the body BD output the highest intensities as their detection results and 30 degrees on the human sensor 21fr in the 90-degree angle range is obtained based on the intensity ratio by reference to the table, then the relative angle of the object is 75 degrees (45 degrees+30 degrees) with respect to the front of the body (because it is 30 degrees forward within the 90-degree angle range on the right side of the body).

On the other hand, when simply the presence/absence of an infrared emitting object is to be detected, basically only eight relative angles with respect to the body are detected. Specifically, if only one human sensor 21 detects an object and outputs the detection result, the angle of that human sensor 21 is regarded as the relative angle; if two human sensors 21 detect an object and output the detection results, the middle angle between the angles of these two human sensors 21 is regarded as the relative angle; and if three humans sensors 21 detect an object and output the detection results, the angle of the center human sensor among them regarded as the relative angle. In other words, when an even number of human sensors are provided at regular intervals, the relative angle is calculated from the middle point between two central human sensors; and when an odd number of human sensors are provided at regular intervals, the relative angle is calculated from the center human sensor.

Having obtained the relative angle in this way, the right and left drive wheels are driven to turn the body BD by the amount equivalent to the relative angle to make it face the object. For this purpose, the CPU 11 instructs the motor drivers 41R and 41L to turn the right and left drive wheel motors 42R and 42L in opposite directions by a prescribed amount so that the body rotates on the same spot.

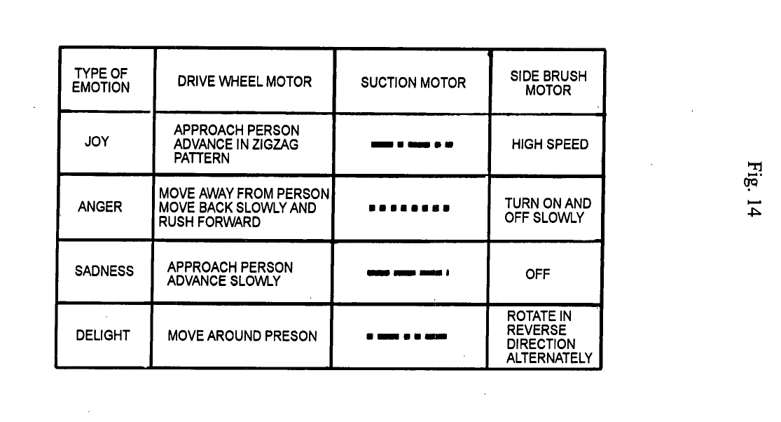

At step S404, the type of emotion to be expressed is selected. As shown in FIG. 14, four types of emotion can be expressed: joy, anger, sadness and delight. Various methods of selecting the type of emotion are available. It is also possible to use various sensors dedicated to emotion type selection. In this embodiment, random numbers are generated and the type of emotion is randomly determined based on the generated random numbers.

After emotion type selection at step S404, the system performs a motion and generates a sound as appropriate according to the type of emotion decided at steps S406 to 410. FIG. 14 is a table which shows an example of the relationship among the type of emotion, motion and sound.

To express “joy,” the system simulates a pet dog approaching to fawn on its guardian by making the body advance toward the person in a zigzag pattern while rotating the side brushes at high speed. “Joy” is also expressed by a sound pattern as follows: the suction motor is driven for a short time and then for a long time and this drive pattern is repeated to continuously generate short and long suction sounds alternately.

To express “anger,” the system simulates a pet dog intimidating a suspicious individual by making the body once move back from the person slowly and suddenly rush toward the person. At this time, the side brushes are rotated at low speed intermittently. The suction motor is driven at short intervals intermittently and repeatedly to make a suction sound repeatedly to express an anger with an intimating motion.

To express “sadness,” the system simulates a pet dog approaching the guardian sorrowfully by making the body advance toward the person slowly. At this time, the side brushes do not move. The suction motor is driven with low power at long intervals to make a sound similar to a dog's whining.

An expression of “delight” maybe similar to an expression of “joy.” In this embodiment, to express “delight,” the system simulates a pet dog running around the guardian by making the body move around the person by alternate reverse rotations of the side brushes. The suction motor is driven for a short time twice and then for a long time once and this drive pattern is repeated to make a combination of short and long suction sounds repeatedly to express “delight.”

These motions are categorized by type of emotion according to the decisions made at steps S406 to S410. For joy, the system goes to steps S412 to S416; for anger, to steps S418 to S422; for sadness, to steps S424 to S428; and for delight, to steps S430 to S434.

For expression of joy, at step S412 the drive mechanism realizes zigzag forward motion by rotating the right and left drive wheel motors 42R and 42L by the same amount alternately. At step S414, in order to generate a suction sound pattern which expresses joy, the pattern of short suction motor drive followed by long suction motor drive is repeated while power is supplied through the motor driver 56. At step S416, power is supplied through the motor drivers 53R and 53L so that the side brushes rotate at high speed.

For expression of anger, at step S418 the body is driven by the drive mechanism so as to move back slowly then suddenly go forward by rotating the right and left drive wheel motors 42R and 42L by the same amount in the same way as above. At step S420, in order to generate a suction sound pattern which expresses anger, a short intermittent drive pattern of the suction motor 55 is repeated while power is supplied through the motor driver 56. At step S422, power is supplied through the motor drivers 53R and 53L so that the side brushes turn on and off slowly.

For expression of sadness, at step S424 the body is driven by the drive mechanism so as to move forward slowly by rotating the right and left drive wheel motors 42R and 42L by the same amount at low speed. At step S426, in order to generate a suction sound pattern which expresses sadness, a long, weak drive pattern of the suction motor 55 is repeated while power is supplied through the motor driver 56. At step S428, power supply through the motor drivers 53R and 53L is stopped to stop motion of the side brushes.

For expression of delight, at step S430 the body is driven by the drive mechanism so as to move around the person. This is achieved by spinning the body 90 degrees from its current position and moving it along a circle with a predetermined radius. Here, the rotation amount of the right and left drive wheel motors 42R and 42L is determined for this circling motion. At step S432, in order to generate a suction sound pattern which expresses delight, a drive pattern of the suction motor 55 which consists of two short drives followed by a long drive is repeated while power is supplied through the motor driver 56. At step S434, power is supplied through the motor drivers 53R and 53L so that the side brushes turn in the reverse direction alternately.

The system is so programmed that, upon detection of a human body, either of the above emotional expressions is performed to make the self-propelled cleaner move like a pet while a suction sound characteristic of the vacuum cleaner is effectively used to enhance the effect of the emotional expression.

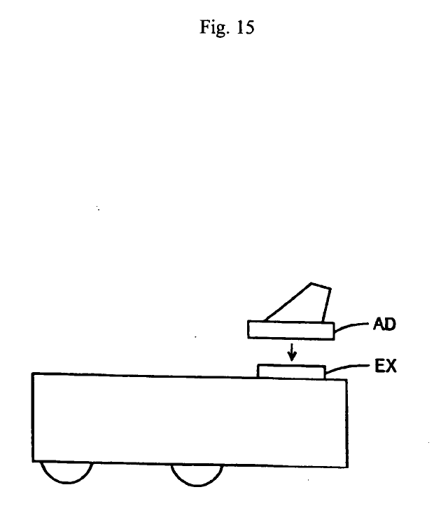

FIG. 15 shows an adapter AD which is mounted on the exhaust hole EX to vary the suction sound. The exhaust hole pipe EX takes the form of a short cylinder protruding from the top backside surface of the body BD; and the adapter AD consists of a short cylindrical portion attachable to the cylindrical exhaust hole pipe and a duct portion tapered from the short cylindrical portion. The inside of the duct is so shaped as to make a sound like a whistle while air is exhausted. Alternatively, it is possible to arrange that different forms of duct are available to make different sound tones so that the user can change the duct to choose a desired sound tone among several sound tone options.

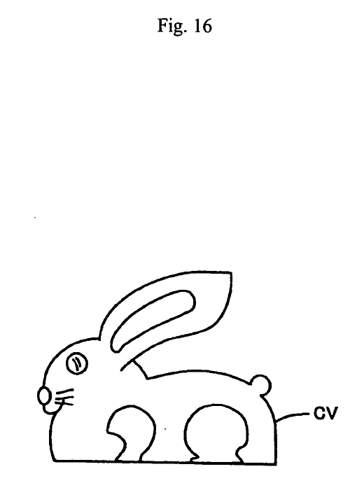

In order to make it look like a stuffed toy to emphasize its friendliness as a pet, a cover CV as shown in FIG. 16 may be attachable. In this case, several touch sensors may be attached inside the cover so that an emotional expression is chosen according to the result of detection by the touch sensors.

For example, if a touch sensor senses the user stroking the body, the expression of joy is chosen; if the user stops stroking while the action to express joy is underway, the expression of anger is chosen; if a touch sensor senses the user beating it, the expression of sadness is chosen; and when the action to express joy continues long, the expression of delight is chosen. These touch sensors are connected to the bus 14 through a prescribed interface and the result of detection by the sensors is accessible from the CPU 11.

As explained so far, in this self-propelled cleaner, after selection of the type of emotion at step S404, an operation step sequence appropriate to the selected type of emotion is chosen at steps S406 to S410 where steps S412 to S416 are carried out for joy, S418 to S422 for anger, S424 to S428 for sadness, and S430 to S434 for delight. At steps S414, S420, S428 and S432, the pattern of power supply to the suction motor is determined to vary the suction sound pattern according to the selected type of emotion to express an emotion.

According to the present invention, the suction motor is controlled to vary the suction sound to make an emotional expression so that a pet based on the unique features of the self-propelled cleaner is realized.

1. A self-propelled cleaner having a body with a vacuum cleaning mechanism driven by a suction motor and a drive mechanism with drive wheels at the left and right sides of the body whose rotation can be individually controlled for steering and driving the cleaner,
the cleaning mechanism having:
side brushes protruding outward from both sides of the body;
side brush motors for driving the side brushes; and
an adapter which is mounted in a suction channel and an exhaust channel for the suction motor to vary the suction sound,
the cleaner further comprising:
an emotion type selection processor which has a human sensor to detect a human body and selects the type of emotion to be expressed;
a suction sound control processor which controls the rotation of the suction motor to vary the suction sound depending on the selected type of emotion; and
a motion control processor which controls the drive mechanism to selectively make the body approach a human body, move away from a human body or move around a human body depending on the selected type of emotion.

2. A self-propelled cleaner having a body with a vacuum cleaning mechanism driven by a suction motor, and a drive mechanism capable of steering and driving the cleaner, comprising:
an emotion type selection processor which has a human sensor to detect a human body and, upon detection of a human body, selects the type of emotion to be expressed;
a suction sound control processor which controls the rotation of the suction motor to vary the suction sound depending on the selected type of emotion; and
a motion control processor which controls the drive mechanism to control motion of the body depending on the selected type of emotion.

3. The self-propelled cleaner as described in claim 2, further comprising an adapter which is mounted in a suction channel and an exhaust channel for the suction motor to vary the suction sound.

4. The self-propelled cleaner as described in claim 2, wherein the cleaning mechanism has side brushes protruding outward from both sides of the body and side brush motors for driving the side brushes and the side brush motors are controlled depending on the selected type of emotion.

5. The self-propelled cleaner as described in claim 2, wherein the motion control processor enables the body to approach a human body, move away from a human body or move around a human body through the drive mechanism.

6. The self-propelled cleaner as described in claim 2, wherein the motion control processor has an operation mode select switch which is used to select either an automatic cleaning mode or a pet mode.

7. The self-propelled cleaner as described in claim 2, wherein upon detection of a human body by the human sensor, the motion control processor positions the body so as to make it face the human body.

8. The self-propelled cleaner as described in claim 7, wherein the human sensor consists of a plurality of human sensors which output results of infrared intensity detection and the motion control processor obtains the highest intensity detection result outputs from two human sensors and detects the angle of an infrared emitting body within an angle range between the detection ranges of these human sensors.

9. The self-propelled cleaner as described in claim 8, wherein the motion control processor is so designed as to reference a table prepared in advance based on experimentation in which the intensity ratio of detection result outputs of two human sensors is calculated, the table storing the relation between intensity ratio and angle, the table being served for determination of the angle of an object to be detected within the angle range between the two human sensors, and also for determination of the relative angle based on the locations of the two human sensors, the locations being determined using their detection result outputs.

10. The self-propelled cleaner as described in claim 7, wherein the human sensor consists of a plurality of human sensors outputting the result of detection about the presence or absence of an infrared emitting object; and if only one human sensor detects an object and outputs the result of detection, the angle of the human sensor which has outputted the detection result is regarded as the relative angle; if two human sensors detect an object and output the detection results, the middle angle between the angles of these two human sensors is regarded as the relative angle; and if three humans sensors detect an object and output the detection results, the angle of the center human sensor is regarded as the relative angle.

11. The self-propelled cleaner as described in claim 2, wherein the motion control processor and the suction sound control processor respectively enable the body to perform a motion and generate a sound to express joy, anger, sadness and delight.

12. The self-propelled cleaner as described in claim 11, wherein, in order to express “joy,” the motion control processor simulates a pet dog approaching to fawn on its guardian by making the body advance toward a person in a zigzag pattern and rotating the side brushes at high speed while the suction sound control processor drives the suction motor for a short time and then for a long time and repeats this drive pattern to continuously generate short and long suction sounds alternately.

13. The self-propelled cleaner as described in claim 11, wherein, in order to express “anger,” the motion control processor simulates a pet dog intimidating a suspicious individual by making the body once move back from a person slowly and suddenly rush toward the person and rotating the side brushes at low speed intermittently while the suction sound control processor drives the suction motor at short intervals intermittently and repeats this drive pattern.

14. The self-propelled cleaner as described in claim 11, wherein, in order to express “sadness,” the motion control processor simulates a pet dog approaching the guardian sorrowfully by making the body advance toward a person slowly without motion of the side brushes while the suction sound control processor drives the suction motor with low power at long intervals and repeats this drive pattern.

15. The self-propelled cleaner as described in claim 11, wherein in order to express “delight,” the motion control processor simulates a pet dog running around the guardian by making the body go around a person by alternate reverse rotations of the side brushes while the suction sound control processor drives the suction motor for a short time twice and then for a long time once and repeats this drive pattern.

16. The self-propelled cleaner as described in claim 2, wherein a cover can be attached to make it look like a stuffed toy and a touch sensor is mounted inside the cover so that the emotion type selection processor chooses an emotional expression according to the result of detection by the touch sensor.

17. The self-propelled cleaner as described in claim 16, wherein the emotion type selection processor works depending on the result of detection by the touch sensor so that if the touch sensor senses the user stroking the body, the expression of joy is chosen; if the user stops stroking while the action to express joy is underway, the expression of anger is chosen; if the touch sensor senses the user beating it, the expression of sadness is chosen; and when the action to express joy continues long, the expression of delight is chosen.
